(19) United States
(12) Patent Application Publication
(10) Pub. No.: US 2011/0182504 A1
(43) Pub. Date: Jul. 28, 2011

(54) MODULAR COLOR MANAGEMENT SYSTEM ARCHITECTURE

(75) Inventors: Rocklin Sloan, San Jose, CA (US); John Haikin, Fremont, CA (US)

(73) Assignee: CANON KABUSHIKI KAISHA, Tokyo (JP)

(21) Appl. No.: 12/696,033

(22) Filed: Jan. 28, 2010

(51) Int. Cl. G06K 9/36

(52) U.S. Cl. 382/162; 382/305

(57) ABSTRACT

Color management converting source-side color images into destination-side color images. A module library includes module entries corresponding to function modules implementing color processing functionalities. Each module entry includes a module locator and input and output interface definitions, and some include a profile interface definition. A profile library includes profile entries corresponding to sources of parameters. Profile entries include a profile locator and a profile interface definition. A script specifying a sequence of function modules and sources of parameters is received and interpreted. The module library is accessed to confirm compatibility of the input interface definition for one function module and the output interface definition for an immediately preceding function module. The profile library is accessed to confirm compatibility of the profile interface definitions for the source of parameters and the function module. The color transformation workflow is built based on the compatibility of the interface definitions.

### FIELD

The present disclosure relates to a color management system architecture, and more particularly relates to a color management system having a modularized architecture which builds a color transformation workflow for transforming source-side color image data into corresponding destination-side color image data.

### BACKGROUND

Color management systems are provided to convert color between color device representations of a source and a destination color device such that the appearance of color fidelity is maintained.

Color management systems are ordinarily structured to exhibit fixed functionality and to behave in a fixed manner. In other words, the processing of a color takes a fixed functional route through various color transform modules. Some color management systems accept parameters for the transform modules, which allow for a fine-tuning adjustment in the degree or amount of transformation, even though the nature of the transform remains unchanged. But in general, functionality of color management systems is ordinarily rigid and inflexible, except in the supply of parameters which drive functionality.

As one example, the Windows Color System (WCS) is a measurement-based color management system in which devices are represented by a combination of measurement information stored in a profile and a device model. More specifically, a device model, an appearance model and a gamut mapping model are selected, together with an inverse device model and an inverse appearance model. Parameters which are stored in profiles are provided to each model in order to drive color management.

Thus, similar to other typical color management systems, the color management workflow of WCS is rigid. Accordingly, it is not usually possible to accommodate a change in the functionality of WCS, such as the introduction of a new color space, which entails new color transforms and new interfaces.

### SUMMARY

Recently, various color management technologies have emerged which do not typically fit into existing color management systems. Because typical color management systems are often inflexible, it is ordinarily necessary to build a new color management system in order to accommodate new color management techniques. For example, some emerging color management techniques involve spectral image data, and it is ordinarily necessary to build a new color management system in order to introduce transforms into and out of a spectral color space.

Extending the capabilities of a color management system is becoming increasingly important due to advances in color technologies. Current color management systems, which are typically based on colorimetric or appearance based color transformations, are not ordinarily adequate for performing image-based color management, multispectral color management, or sophisticated tone-mapping techniques that are being developed for improved image reproduction.

The foregoing situation is addressed through the provision of a modular color management system architecture which flexibly builds customized color management transformation sequences by sequentially arranging function modules which encapsulate color processing functionalities, such that new functionalities and new color spaces can be easily accommodated.

Thus, in an example embodiment described herein, color management is architected so as to convert source-side color image data into counterpart destination-side color image data. Two libraries are provided, a module library and a profile library. The module library includes plural module entries each corresponding to a respective function module which implements color processing functionality. Each module entry includes at least a module locator specifying a location for the function module, an input interface definition which specifies an interface for input to the function module, and an output interface definition which specifies an interface for output from the function module. For at least some of the module entries of the module library, the module entry further includes a profile interface definition which specifies an interface for supply of parameters which characterize the function module. The profile library includes plural profile entries each corresponding to a respective source of parameters that characterize a function module. Each profile entry includes at least a profile locator specifying a location for the source of parameters, and a profile interface definition which specifies an interface for supply of the parameters to the function module characterized thereby.

A script specifying at least a sequence of function modules and sources of parameters is received and interpreted, such as by a script-driven configurator. The module library is accessed to confirm that the input interface definition for one function module specified in the script is compatible with the output interface definition for an immediately preceding function module specified in the script. The profile library is accessed to confirm that the profile interface definition for each specified source of parameters is compatible with the profile interface definition of the function module characterized thereby. A color transformation workflow is built from the sequence of function modules and sources of parameters specified by the script, responsive to confirmation of compatibility of the interface definitions.

By virtue of this arrangement, color processing functionalities can be flexibly arranged to build color transformation workflows customized according to a script to accommodate new color management techniques. For example, function modules for a spectral color space can be specified in the script such that spectral color management techniques are incorporated into the color transformation workflow. Thus, by specifying function modules in a script, a spectral color transformation workflow can be more easily constructed.

Situations sometimes arise where there are inconsistencies between an input interface definition for a first function module and an output interface definition for a second function module which immediately precedes the first function module. Such situations might be intentional, or they might arise from errors in the script. In some example embodiments these inconsistencies are resolved.

In one example embodiment, the inconsistencies are resolved by searching through the module library to identify at least one intermediate function module which provides a consistent pathway of interface definitions, and by inserting the at least one intermediate function module between the first function module and the second function module. In this case, the at least one intermediate function module has an input interface definition consistent with the output interface definition for the first function module and an output interface definition consistent with the input interface definition for the second function module.

By virtue of resolving inconsistencies by the above-discussed arrangement, it becomes possible in many cases to build a color transformation workflow even in situations where there are incompatibilities in the interface definitions between successive function modules specified by the script.

Furthermore, in some embodiments, if by searching through the module library a plurality of candidates are identified, each of which resolves the inconsistencies, one of the plurality of candidates is selected to resolve the inconsistencies, such as by user input, or by automatic selection which resolves the inconsistencies based on an intent of the color transformation workflow, or by use of metadata of an image, or by use of color image data for an image.

In example embodiments, the script is refined based on a predetermined criteria. The predetermined criteria is, for example, one, or any combination of, a user input, information included in the profile entry, and image attributes. Additionally, in some embodiments, a raw module list is generated based on the script. Furthermore, in some example embodiments, a module interface table is generated based on the module library.

In some embodiments, for at least some of the module entries in the module library, the module entry comprises plural input interface definitions or plural output definitions, each including two or more of at least a device-dependent interface definition, an XYZ interface definition, an L*a*b interface definition, a Jab interface definition, a profile connection space (PCS) interface definition, and a spectral interface definition.

Because some of the module entries comprise plural interface definitions, there is a greater probability that modules can be found with naturally compatible interfaces, and the occurrence of inconsistencies between interfaces may be resolved more readily.

In other example embodiments, for at least some of the profile entries of the profile library, the profile entry includes plural profile interface definitions.

Because some of the profile entries comprise plural profile interface definitions, there is a greater probability of compatibility between the profile interface definition for a module and the specified source of parameters that characterize that module.

In other example embodiments, for at least some of the profile entries of the profile library, the source of parameters at the location specified by the profile locator generates the parameters from internal information.

Furthermore, in some other example embodiments, for at least some of the profile entries of the profile library, the source of parameters at the location specified by the profile locator generates the parameters from internal information pertaining to ICC PCS viewing conditions.

In alternate embodiments, for at least some of the profile entries of the profile library, the source of parameters at the location specified by the profile locator generates the parameters by using access to a file system to acquire information from which the parameters are generated.

In some example embodiments, the module library further includes supplemental function modules. In this case, each supplemental function module executes functionality to supply supplemental information to a function module which implements color processing functionality, the functionality being at least one of interpreting a device profile and generating a gamut boundary description. In addition, each supplemental function module supplies supplemental information to the function module via a supplemental interface, and the supplemental information includes at least one of device characterization data, viewing conditions, and gamut boundary descriptions.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a representative view of computing equipment relevant to one example embodiment.

FIG. 2 is a detailed block diagram depicting the internal architecture of the host computer shown in FIG. 1.

FIGS. 3A and 3B are representational views for explaining the linking of function modules according to an example embodiment.

FIG. 4 is a view for explaining software architecture of a modular color management module according to an example embodiment.

FIG. 5 is a detailed view for explaining software architecture of a CMS workflow configurator module according to an example embodiment.

FIG. 6 is a flow diagram for explaining color processing in a CMS workflow configurator module according to an example embodiment.

FIG. 7 is a representational view of a color transformation workflow according to an example embodiment.

### DETAILED DESCRIPTION

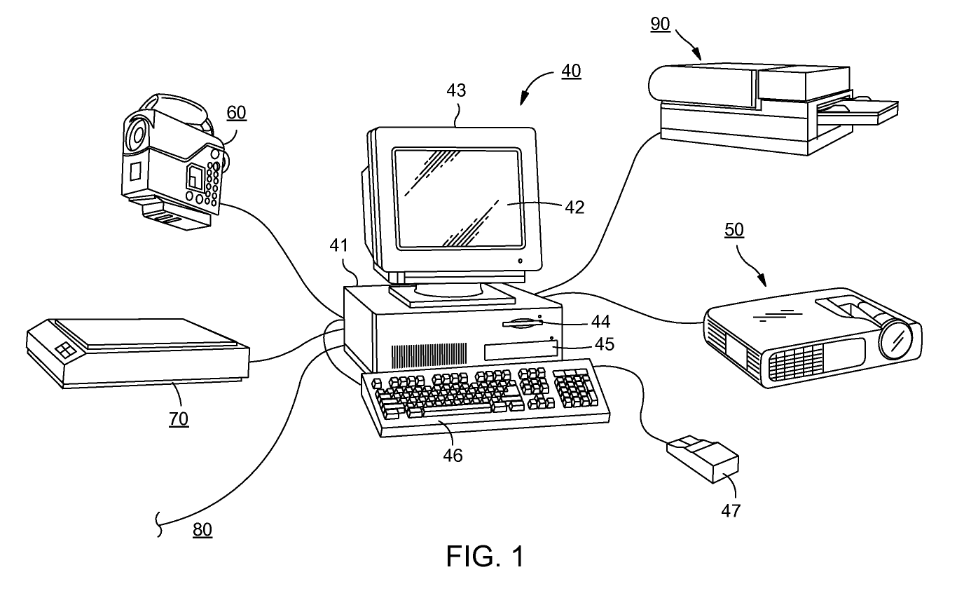

FIG. 1 is a representative view of computing equipment, peripherals and digital devices, relevant to one example embodiment. Computing equipment 40 includes host computer 41 which generally comprises a programmable general purpose personal computer (hereinafter “PC”) having an operating system such as Microsoft® Windows® or Apple® Mac OS® or LINUX, and which is programmed as described below so as to perform particular functions and in effect to become a special purpose computer when performing these functions. Computing equipment 40 includes color monitor 43 including display screen 42, keyboard 46 for entering text data and user commands, and pointing device 47. Pointing device 47 preferably comprises a mouse for pointing and for manipulating objects displayed on display screen 42.

Host computer 41 also includes computer-readable memory media such as computer fixed disk 45 and DVD disk drive 44, which are constructed to store computer-readable information such as computer-executable process steps. DVD disk drive 44 provides a means whereby host computer 41 can access information, such as image data, computer-executable process steps, application programs, etc. stored on removable memory media. In an alternative, information can also be retrieved through other computer-readable media such as a USB storage device connected to a USB port (not shown), or through network interface 80. Other devices for accessing information stored on removable or remote media may also be provided.

Projector 50 is a first example of a color output device, and in this example is an RGB or RGBW projector, such as a DLP™ digital projector or other display device that projects images in accordance with image data from host computer 41 onto a projection screen (not shown). Projector 50 may be an HDR device capable of projecting HDR images. Projector 50 projects images onto a display screen (not shown) by using additive light combinations of red (R), green (G) and blue (B) colorant lights. In addition, and particularly in a case of an HDR device, projector 50 also uses a white (W) light so as to increase the brightness/luminance of projected images and thereby project HDR images with good fidelity over a large dynamic range.

Printer 90 is a second example of a color output device, and in this example is a color laser printer which forms color images on a recording medium such as paper or transparencies or the like. Printer 90 forms color images using cyan, magenta, yellow and black colorants, although printers and other devices can be used which form color images using other colorant combinations that might or might not include black, such as a CMYKOG device.

Digital color scanner 70 is a first example of a color input device, and is provided for scanning documents and images and sending the corresponding image data to host computer 41.

Digital color camera 60 is a second example of a color input device, and is provided for sending digital image data to host computer 41.

Of course, host computer 41 may acquire digital image data from other sources such as a digital video camera, a local area network or the Internet via network interface 80 Likewise, host computer 41 may interface with other color output devices, such as color output devices accessible over network interface 80.

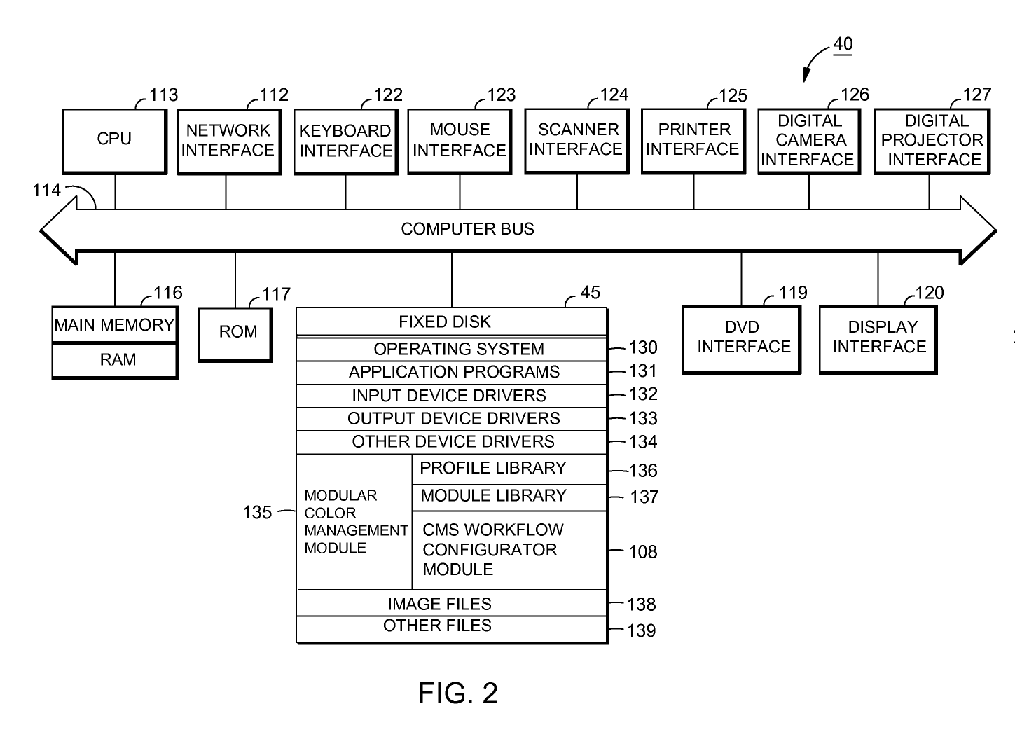

FIG. 2 is a detailed block diagram showing the internal architecture of host computer 41 of computing equipment 40. As shown in FIG. 2, host computer 41 includes central processing unit (CPU) 113 which interfaces with computer bus 114. Also interfacing with computer bus 114 are fixed disk 45, network interface 112, random access memory (RAM) 116 for use as a main run-time transient memory, read only memory (ROM) 117, DVD disk interface 119, display interface 120 for monitor 43, keyboard interface 122 for keyboard 46, mouse interface 123 for pointing device 47, scanner interface 124 for scanner 70, printer interface 125 for printer 90, digital camera interface 126 for digital camera 60, and digital projector interface 127 for digital projector 50.

RAM 116 interfaces with computer bus 114 so as to provide information stored in RAM 116 to CPU 113 during execution of the instructions in software programs such as an operating system, application programs, color management modules, and device drivers. More specifically, CPU 113 first loads computer-executable process steps from fixed disk 45, or another storage device into a region of RAM 116. CPU 113 can then execute the stored process steps from RAM 116 in order to execute the loaded computer-executable process steps. Data such as color images or other information can be stored in RAM 116, so that the data can be accessed by CPU 113 during the execution of computer-executable software programs, to the extent that such software programs have a need to access and/or modify the data.

As also shown in FIG. 2, fixed disk 45 contains computer-executable process steps for operating system 130, and application programs 131, such as word processing programs or graphic image management programs. Fixed disk 45 also contains computer-executable process steps for device drivers for software interface to devices, such as input device drivers 132, output device drivers 133, and other device drivers 134. Image files 138, including color image files, and other files 139 are available for output to color output devices and for manipulation by application programs.

Modular color management module (MCMM) 135 comprises computer-executable process steps executed by a computer for building a color transformation workflow for transforming source-side color image data into corresponding destination-side color image data. MCMM 135 builds the color transformation workflow so as to maintain good color fidelity for color images that are transferred from a source device to a destination device, such as the transfer of color image data from capture by digital camera 60 to display by projector 50. It should be appreciated that MCMM 135 is not limited to color transformation workflows between real devices, and that MCMM 135 also builds the color transformation workflow so as to maintain good color fidelity for color images that are transferred between any type of color space, such as, for example, a real device color space, a mathematical color space (e.g., sRGB, scRGB, ProPhoto, AdobeRGB), and the like. As shown in FIG. 2, MCMM 135 includes, at least, profile library 136, module library 137, and CMS workflow configurator module 108.

Module library 137 includes plural module entries each corresponding to a respective function module which implements color processing functionality. For example, a function module may encapsulate color management operations such as device modeling, color appearance modeling, or gamut mapping. The function modules are used by MCMM 135 to construct the color transformation workflow.

In this example embodiment, there are two types of function modules. The first type is a color processing function module which performs color processing on pixels, images and movies, for example. The second type is a supplemental function module which performs tasks that supplement functionality of the color processing function modules by executing functionality to supply information to a function module, such as interpreting a device profile and generating a gamut boundary description, for color management.

For example, in this embodiment, the following types of function modules are included in the module library 137:
Device Model
Appearance Model
Gamut Mapping Model
Device Profile Model
Viewing Conditions Model
Gamut Boundary Description (GBD) Builder
Interim Connection Space (ICS) Builder

More specifically, the specific function modules included in module library 137 are:
Device Model (Forward WCS Baseline CRT Monitor)
Device Model (Inverse WCS Baseline CRT Monitor)
Device Model (Inverse WCS Baseline CMYK Printer)
Device Model (Forward ICC Baseline CRT Monitor)
Device Model (Inverse ICC Baseline CMYK Printer)
Device Model (Forward Spectral)
Device Model (Inverse Spectral)
Appearance Model (Forward CIECAM02)
Appearance Model (Inverse CIECAM02)
Appearance Model (Forward sCAM02)
Appearance Model (Inverse sCAM02)
Gamut Mapping Model (Detail Preserving SGCK)
Gamut Mapping Model (Image Specific Dynamic GMA)
Gamut Mapping Model (Image Specific Image Gamut)
Gamut Mapping Model (Spatial GMA)
Gamut Mapping Model (Spectral to Spectral)
Gamut Mapping Model (Colorimetric to Spectral)
Gamut Mapping Model (Pyramid Tone-Mapper)
Gamut Mapping Model (iCam/iCAM06 Tone-Mapper)
Gamut Mapping Model (Retinex Tone-Mapper)
Device Profile Model (WCS)
Device Profile Model (ICC)
Device Profile Model (Spectral)
Viewing Conditions Model (CIECAM02)
Viewing Conditions Model (sCAM02)
Gamut Boundary Description (GBD) Builder
Interim Connection Space (ICS) Builder

Each module entry includes at least a module locator specifying a location for the function module so that the function module itself is not necessarily part of the module library 137. This permits the function module to be located remotely of module library 137. In addition, each module entry further includes at least an input interface definition which specifies an interface for input to the function module, and output interface definition which specifies an interface for output from the function module. Data interfaces allow data such as, image data, color data, attribute data and control data, to flow between function modules. For at least some of the module entries of module library 137, the module entry includes plural input interface definitions or plural output definitions, each including two or more of at least a device-dependent interface definition, an XYZ interface definition, an L*a*b interface definition, a Jab interface definition, a profile connection space (PCS) interface definition, and a spectral interface definition.

Similar to function modules, there are two categories of interface definitions in this embodiment. The first is a color data interface definition which handles color pixels, images and movies in various color formats, such as device colors, measurement colors and appearance colors. The second is a supplemental data interface definition which handles information that will supplement color management, such as device characterization data, viewing conditions and gamut boundary descriptions.

For example, in this embodiment, the following categories of interface definitions are included in the module library 137:
Device Color Data
Measurement Color Data
Appearance Color Data
Device Profile Data
Device Characterization Data
Viewing Conditions Data
Gamut Boundary Description Data

More specifically, the specific interface definitions included in the module library 137 are:
D Device Color Data (N-Channel)
M1 Measurement Color Data (CIEXYZ Tristimulus)
M2 Measurement Color Data (Spectral Reflectance)
A1 Appearance Color Data (CIECAM02)
A2 Appearance Color Data (ICS Spectral Data)
C Device Characterization Data
Viewing Conditions Data
B Gamut Boundary Description Data
P1 Device Profile Data (WCS)
P2 Device Profile Data (ICC)
P3 Device Profile Data (Spectral)
P4 Viewing Conditions Profile Data (CIECAM02)
P5 Viewing Conditions Profile Data (sCAM02)
P6 Interim Connection Space Profile Data (ICS)
G1 Gamut Mapping Profile Data (SGCK)
G2 Gamut Mapping Profile Data (Spectral S-S)
G3 Gamut Mapping Profile Data (Spectral C-S)
G4 Gamut Mapping Profile Data (Pyramid)
G5 Gamut Mapping Profile Data (iCAM/iCAM06)
G6 Gamut Mapping Profile Data (Retinex)
G7 Gamut Mapping Profile Data (Dynamic GMA)
G8 Gamut Mapping Profile Data (Spatial GMA)
G9 Gamut Mapping Profile Data (Image Gamut)

In addition, for at least some of the module entries of the module library, the module entry further includes a profile interface definition which specifies an interface for supply of parameters which characterize the function module.

Generally, a function module receives data through the input interfaces, processes the received data according to the color processing functionality which the function module implements, and sends the results to the output interfaces.

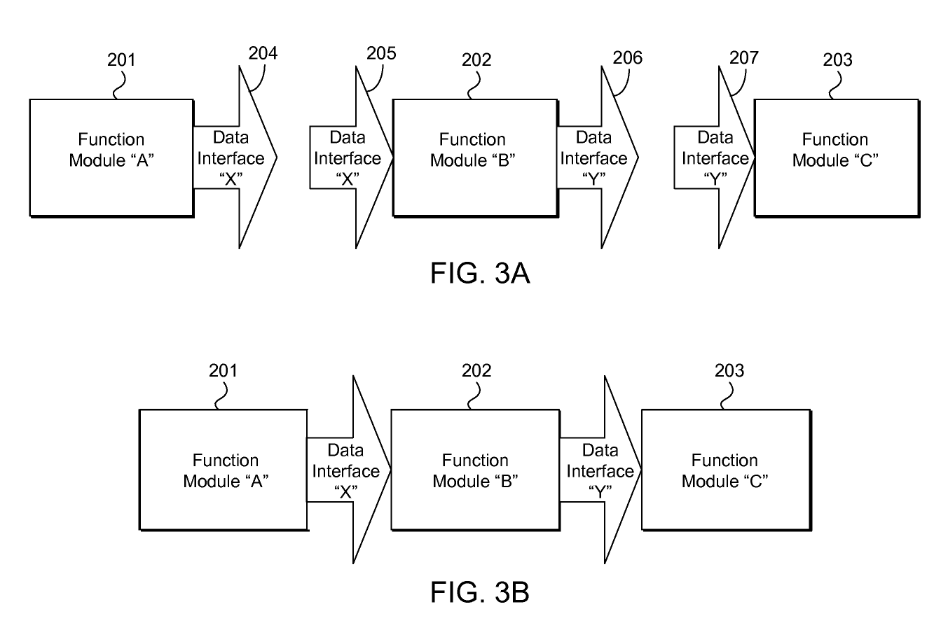

For example, exemplary Function Modules “A”, “B” and “C” are shown in FIGS. 3A and 3B.

As shown in FIG. 3A, Function Module “A” (201) has an output interface definition (204) of “X”, Function Module “B” (202) has an input interface definition (205) of “X” and an output interface definition (206) of “Y”, and Function Module “C” (203) has an input interface definition of “Y” (207). The function modules can be linked together to build a color transformation workflow if the input interface definition of one function module matches the output interface definition of an immediately preceding function module, as shown in FIG. 3B

A function module can be accessed through a variety of sources. In the example embodiment, function modules are built-in to the color management system and stored on fixed disk 45. In other embodiments, function modules are provided as plug-ins or embedded into profile entries. Furthermore, function modules can be implemented as machine-code programs or as interpretive code using either pseudo-code or compiled source code, or a combination thereof.

Returning to FIG. 2, profile library 136 includes plural profile entries, each corresponding to a respective source of parameters that characterize a function module. Each profile entry includes at least a profile locator specifying a location for the source of parameters, so that the profile entry itself is not necessarily part of profile library 136. This permits the profile entry to be located remotely from profile library 136. In addition, each profile entry further includes at least a profile interface definition which specifies an interface for supply of the parameters to the function module characterized thereby. In addition, for at least some of the profile entries of the profile library, the profile entry includes plural profile interface definitions. In the example embodiment, profile interface definitions are text interfaces. In other embodiments, profile interface definitions are binary interfaces or network interfaces.

In this embodiment, the profile interface definitions include the same interface definitions as those for modules in module library 137.

In the example embodiment, for at least some of the profile entries of the profile library, the source of parameters at the location specified by the profile locator generates the parameters from internal information. In other embodiments, the parameters are generated from internal information pertaining to ICC PCS viewing conditions. In still other embodiments, the parameters are generated by using access to a file system to acquire information from which the parameters are generated.

In some embodiments, profile library 136 comprises computer-executable process steps executed by a computer for accessing the profile entries. Furthermore, a profile interface definition may be constructed to accommodate for active feedback, for example, such that a profile entry may be calibrated.

In the example embodiment, profile library 136 and module library 137 are stored in fixed disk 45 as shown in FIG. 2. In other embodiments, profile library 136 and module library 137 are stored inside of devices (e.g., digital camera 60, scanner 70 or printer 90), inside of ROM 117, or inside of any other suitable storage device.

CMS workflow configurator module 108 generally comprises computer-executable process steps that receive and interpret a script specifying at least a sequence of function modules and sources of parameters. CMS workflow configurator module 108 accesses module library 137 to confirm that an input interface definition for one function module specified in the script is compatible with an output interface definition for an immediately preceding function module specified in the script. CMS workflow configurator module 108 accesses profile library 136 to confirm that a profile interface definition for each specified source of parameters is compatible with a profile interface definition of the function module characterized thereby. CMS workflow configurator module 108 builds a color transformation workflow from the sequence of function modules and sources of parameters specified by the script, responsive to confirmation of compatibility of the interface definitions.

The computer-executable process steps for MCMM 135 may be configured as a part of operating system 130, as part of an output device driver such as a printer driver, or as a stand-alone application program such as a color management system. They may also be configured as a plug-in or dynamic link library (DLL) to the operating system, device driver or application program. For example, MCMM 135 according to example embodiments may be incorporated in an output device driver for execution in a computing device, such as a printer driver, embedded in the firmware of an output device, such as a printer, or provided in a stand-alone color management application for use on a general purpose computer. In one example embodiment described herein, MCMM 135 is incorporated directly into the operating system for general purpose host computer 41. It can be appreciated that the present disclosure is not limited to these embodiments and that the disclosed color management module may be used in other environments in which color management is used.

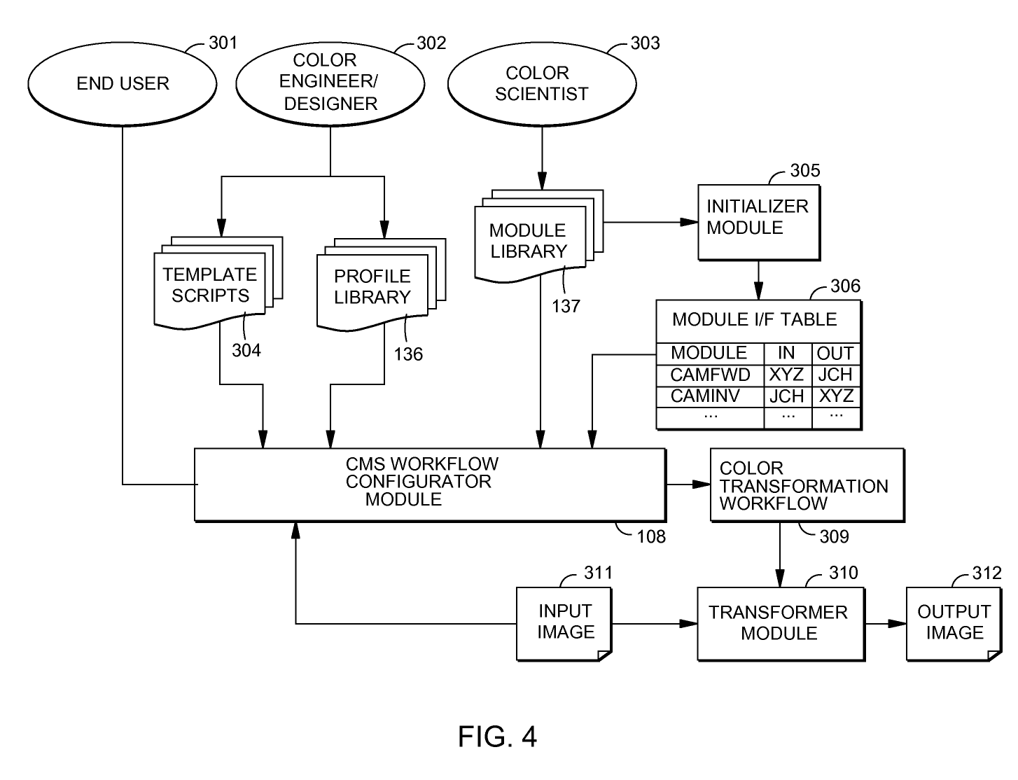

FIG. 4 is a view for explaining software architecture of modular color management module (MCMM) 135. In the embodiment depicted in FIG. 4, there are three types of users interfacing with MCMM 135, namely an end user 301, a color engineer/designer 302 and a color scientist 303.

End user 301 specifies an input image 311, and provides a variety of user input to the CMS workflow configurator module 108. User input includes, for example, a desired processing speed, a preference for color accuracy, an availability of resources, and other user requirements.

Color engineer/designer 302 creates new profile entries for profile library 136, such as a profile entry for printer 90 or digital camera 60. As previously discussed, profile entries correspond to a source of parameters that characterize a particular function module, and each profile entry has a profile interface definition specifying an interface for the supply of parameters to the function module characterized by the particular profile entry. Thus, color engineer/designer 302 has the ability to create and add new profile interface definitions such that profile library 136 is extensible. It should be appreciated that the architecture of MCMM 135 is such that color engineer/designer 302 is able to add new profile interface definitions after deployment of MCMM 135 to end users in the field, without the need to alter or reconfigure the MCMM 135 itself, such that the core processing functionality of MCMM 135 remains unchanged.

In addition, color engineer/designer 302 creates new template scripts and modifies existing template scripts. Template scripts 304 are scripts specifying at least a sequence of function modules and sources of parameters in order to build a color transformation sequence. In the example embodiment, template scripts 304 are text-based scripts. Of course, any suitable type of script may be used in other embodiments.

Color scientist 303 creates new function modules for module library 137. As previously discussed, module library 137 includes plural module entries each corresponding to a respective function module which implements color processing functionality. Thus, color scientist 303 has the ability to add new color processing functionalities by generating new function modules, such that module library 137 is extensible. In this way, module library 137 can be expanded to include new and currently unknown color processing techniques, as well as existing color processing techniques. Each module entry includes at least a module locator, an input interface definition, and output interface definition. Some of the module entries also include a profile interface definition. Thus, color scientist 303 also has the ability to add new interface definitions to module library 137. It should be appreciated that the architecture of MCMM 135 is such that color scientist 303 is able to add new function modules and new interface definitions after deployment of MCMM 135 to end users in the field, without the need to alter or reconfigure the MCMM 135 itself, such that the core processing functionality of MCMM 135 remains unchanged.

In the example embodiment, end user 301, color engineer/designer 302 and color scientist 303 interface with MCMM 135 by using a user interface. Any convenient type of user interface may be used, including, for example, graphic or non-graphic based user interfaces.

MCMM 135 includes initializer module 305 and CMS workflow configurator module 108. Initializer module 305 receives, as input, module entries included in module library 137. Based on the received module entries, initializer module 305 outputs module interface table 306. More specifically, initializer module 305 reads out the module entries included in module library 137 in order to build module interface table 306. If a new function module is added to module library 137, for example when color scientist 303 creates a new function module, initializer module 305 finds the new function module and adds the function module and its corresponding interface definitions to module interface table 306. In the example embodiment, module interface table 306 is a database which identifies the function module and interface definitions for each respective module entry.

CMS workflow configurator module 108 receives, as input, template scripts 304, profile entries from profile library 136, module entries from module library 137, interface definitions for each module entry from module interface table 306, input from end user 301, and input image 311 Based on these inputs, CMS workflow configurator module 108 outputs color transformation workflow 309.

As previously discussed, input from end user 301 includes a desired processing speed, a preference for color accuracy, an availability of resources, and other user requirements in the example embodiment.

Input image 311 is a color image which includes source-side color image data. The source-side color image data is transformed into corresponding destination-side color image data by MCMM 135. In the example embodiment, input image 311 is stored in fixed disk 45. However, it can be appreciated that input image 311 can be stored in any suitable storage device, such as a removable storage device, in other example embodiments.

CMS workflow configurator module 108 receives and interprets template script 304 specifying at least a sequence of function modules and sources of parameters in order to create color transformation workflow 309. Generally, CMS workflow configurator module 108 accesses module library 137 to confirm that the input interface definition for one function module is compatible with the output interface definition for an immediately preceding function module. CMS workflow configurator module 108 accesses profile library 136 to confirm that the profile interface definition for each specified source of parameters is compatible with the profile interface definition of the function module characterized thereby. CMS workflow configurator module 108 arranges the sequence of function modules and sources of parameters specified by template script 304 into a color transformation sequence in order to build color transformation workflow 309, responsive to a confirmation of compatibility of the interface definitions.

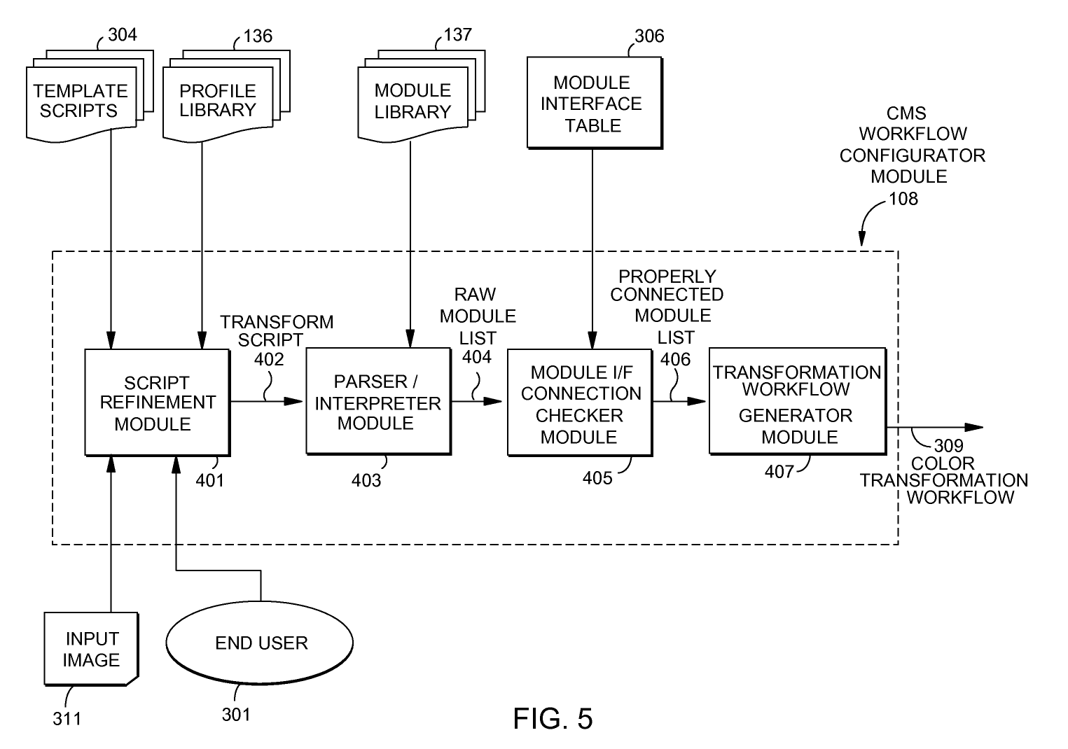

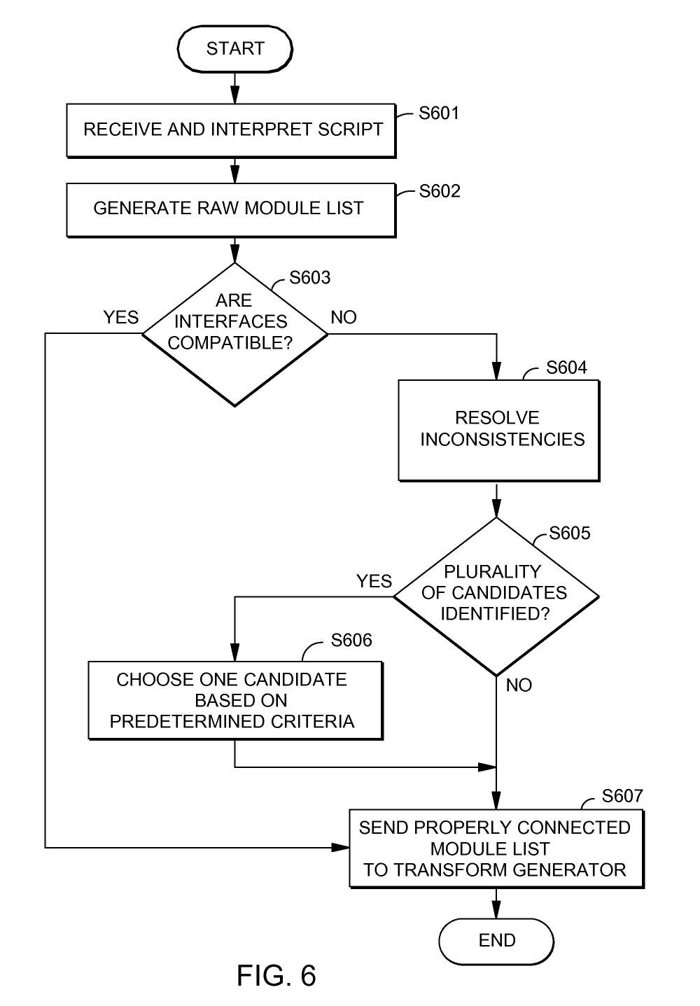

The operation of CMS workflow configurator module 108 will be discussed in more detail below, with reference to FIGS. 5 and 6.

Color transformation workflow 309 generates transformer module 310. Transformer module 310 receives, as input, input image 311. Transformer module 310 transforms source-side color image data for input image 311 into corresponding destination-side color image data for output image 312.

The modules shown in FIG. 4 can be stored in one device, or can be split up and distributed among several devices.

FIG. 5 is a detailed view for explaining software architecture of CMS workflow configurator module 108. As seen in FIG. 5, CMS workflow configurator module 108 includes script refinement module 401, parser/interpreter module 403, module interface connection checker module 405 and transformation workflow generator module 407.

Script refinement module 401 receives, as input, template scripts 304, sources of parameters from profile library 136, input from end user 301 and input image 311. Based on these inputs, script refinement module 401 outputs a refined transform script 402. Thus, script refinement module 401 receives the template script 304 and refines template script 304 in order to generate transform script 402. Template script 304 is refined based on a plurality of criteria, including, for example, user requirements and preferences as indicated by end user 301, information contained in profile entries included in profile library 136, and image attributes of the input image 311. For example, there may be some situations where multiple alternatives exist to build a desired color transformation workflow. In these cases, script refinement module 401 chooses one alternative based on one, or any combination of, a user input, information contained in a profile entry, and image attributes. Image attributes include metadata of an image and color data of an image, such as data contained in an ICC profile.

Parser/Interpreter module 403 receives transform script 402 from script refinement module 401 and interprets transform script 402 to generate a raw module list 404. Raw module list 404 represents a color transformation sequence including function modules and sources of parameters. However, interfaces between modules specified by raw module list 404 are not rigorously checked for compatibility.

In addition, parser/interpreter module 403 accesses module library 137 in order to gather module attribute information for each function module specified in the raw module list 404. Module attribute information includes, for example, input and output interface definitions.

Raw module list 404 is provided to the module interface connection checker module 405, along with the gathered module attribute information.

Module interface connection checker module 405 receives raw module list 404 and associated module attribute information from parser/interpreter module 403 in order to examine the interface definitions between each function module specified by raw module list 404. Module interface connection checker module 405 determines if the interface definitions are compatible by checking if the input interface definition for one function module matches the output interface definition for an immediately preceding function module. For example, if the input interface definition for one function module is CIEXYZ and the output interface definition for the immediately preceding function module is also CIEXYZ, then the interfaces are compatible and there is a valid connection between the pair of function modules.

The operation of module interface connection checker module 405 is explained in more detail below, with reference to FIG. 6.

When module interface connection checker module 405 examines all of the interface definitions between each of the function modules specified by raw module list 404, and determines that all of the interfaces are compatible, a properly connected module list 406 is generated.

Properly connected module list 406 is provided to transformation workflow generator module 407 in order to generate color transformation workflow 309. Transformation workflow generator module 407 generates linkages in the color management system framework in order to prepare for color processing.

FIG. 6 is a flow diagram for explaining color processing in CMS workflow configurator module 108, in relation to the architecture depicted in FIG. 5. The process steps shown in FIG. 6 are computer-executable process steps stored on a computer-readable memory medium such as at 135 on fixed disk 45, and are executed by CPU 113 of host computer 41, so as to implement a color management module which builds a color transform for transforming source-side color image data into corresponding destination-side color image data. Briefly, according to the process steps shown in FIG. 6, template script 304 specifying at least a sequence of function modules and sources of parameters is received and interpreted by CMS workflow configurator module 108. CMS workflow configurator module 108 accesses module library 137 to confirm that the input interface definition for one function module specified in template script 304 is compatible with the output interface definition for an immediately preceding function module specified in template script 304. CMS workflow configurator module 108 accesses profile library 136 to confirm that the profile interface definition for each specified source of parameters is compatible with the profile interface definition of the function module characterized thereby. CMS workflow configurator module 108 builds color transformation workflow 309 from the sequence of function modules and sources of parameters specified by transform script 402, responsive to confirmation of compatibility of the interface definitions.

In more detail, in step S601, script refinement module 401 receives template script 304, sources of parameters from profile library 136, input from end user 301 and input image 311, and interprets and refines template script 304 to generate transform script 402. Parser/interpreter module 403 receives transform script 402 from script refinement module 401 and interprets transform script 402 to generate raw module list 404 in step S602. Raw module list 404 is provided to module interface connection checker module 405, along with module attribute information gathered by parser/interpreter module 403.

In step S603, module interface connection checker module 405 determines whether all of the interface definitions between each of the function modules specified by raw module list 404 are compatible. If yes, module interface connection checker module 405 generates and sends properly connected module list 406 to the transformation workflow generator module 407 in step S607.

In the example embodiment, module interface connection checker module 405 determines whether the interface definitions between each of the function modules are compatible by accessing module interface table 306 to retrieve the corresponding interface definitions for each specified function module. In the example embodiment, the interface definitions are represented by character strings, such as “XYZ”, in module interface table 306. A keyword search is performed by traversing the module interface table 306 in order to determine if the character string representing the input interface definition for one function module specified in the script is compatible with the character string representing the output interface definition for an immediately preceding function module specified in the script. For example, if the character string representing the input interface definitions for a first function module is “XYZ” and the character string representing the output interface definitions for a second function module immediately preceding the first function module is also “XYZ”, then there is a match such that the interface definitions are compatible.

On the other hand, if the module interface connection checker module 405 determines that there are inconsistencies between an input interface definition for a first function module and an output interface definition for a second function module which immediately precedes the first function module, the flow proceeds to step S604 in which the inconsistencies are resolved.

In one example embodiment, the inconsistencies are resolved in step S604 by traversing the module interface table 306 to identify at least one intermediate function module which provides a consistent pathway of interface definitions. A consistent pathway is one such that the at least one intermediate function module has an input interface definition consistent with the output interface definition for the first function module and an output interface definition consistent with the input interface definition for the second function module immediately preceding the first.

For example, if the output interface definition for a first function module is Jab and the input interface definition for a second function module is JCh, then an intermediate function module which has an input interface definition of Jab and an output interface definition of JCh may be inserted between the first and second module to resolve the inconsistency. In this case, module interface connection checker module 405 traverses module interface table 306 in order to search for all function modules having an input interface definition of Jab. Module interface connection checker module 405 then searches the function modules having an input interface definition of Jab for a function module having a corresponding output interface definition of JCh.

One function module or a sequence of function modules may be identified which resolve the inconsistencies when inserted into the color transformation sequence. For example, if the output interface definition of a first function module is RGB and the input interface definition of a second function module is JCh, one possible solution is to insert a function module which converts between RGB and XYZ interface definitions, followed by a function module which converts between XYZ and Jab interface definitions, followed by a function module which converts between Jab and JCh interface definitions. Thus, the function modules can be interchangeably and sequentially arranged in order to provide a consistent pathway of interface definitions.

In this case, module interface connection checker module 405 traverses module interface table 306 in order to search for all function modules having an input interface definition of RGB. Module interface connection checker module 405 then searches these function modules having an input interface definition of RGB for a function module having a corresponding output interface definition of JCh. If such a function module is not found, then for each of the found function modules having an input interface definition of RGB, the module interface connection checker module 405 searches the module interface table 306 in order to search for a function module which has an input interface definition which matches the output interface definition of the function module having an input interface definition of RGB, and which has an output interface definition of JCh. This process is expanded and repeated until a single module, or a sequence of modules, is found that resolves the inconsistency.

A plurality of candidates, each of which resolves the inconsistencies, may be identified. Each candidate may include one intermediate function module or a sequence of intermediate function modules which provide a consistent pathway of interface definitions.

In step S605, it is determined whether a plurality of candidates has been identified by module interface connection checker module 405 in step S604. If only one candidate has been identified (“NO” at step S505), module interface connection checker module 405 inserts the one candidate between the first function module and the second function module which immediately precedes the first function module to generate properly connected module list 406. The properly connected module list 406 is provided to transformation workflow generator module 407 in order to generate color transformation workflow 309 in step S607.

On the other hand, if it is determined in step S605 that a plurality of candidates has been identified by module interface connection checker module 405 (“YES” at step S605), the flow branches to step S606 in which one of the plurality of candidates is selected to resolve the inconsistencies in accordance with a predetermined criteria. The predetermined criteria may include, for example, predetermined criteria provided by user input, an intent of the color transformation workflow, metadata of an image, or color image data for an image. As previously discussed, user input specified by end user 301 includes, for example, a desired processing speed, a preference for color accuracy, an availability of resources, and other user requirements. Furthermore, the inconsistencies may be resolved automatically in accordance with the predetermined criteria, or alternatively, the user may be prompted to select a candidate to resolve the inconsistency.

At step S606, module interface connection checker module 405 inserts the selected candidate between the first function module and the second function module which immediately precedes the first function module to generate properly connected module list 406. In step S607, the properly connected module list 406 is provided to transformation workflow generator module 407 in order to generate color transformation workflow 309.

Color transformation workflow 309 generates transformer module 310. Transformer module 310 receives, as input, input image 311, and transforms source-side color image data for input image 311 into corresponding destination-side color image data for output image 312.

In the example embodiment, output image 312 may be re-input into transformer module 310 as input image 311 in order to further refine the colors of the image.

In the example embodiment, if no intermediate function module is identified which is capable of resolving the inconsistencies, CMS workflow configurator module 108 outputs an error message.

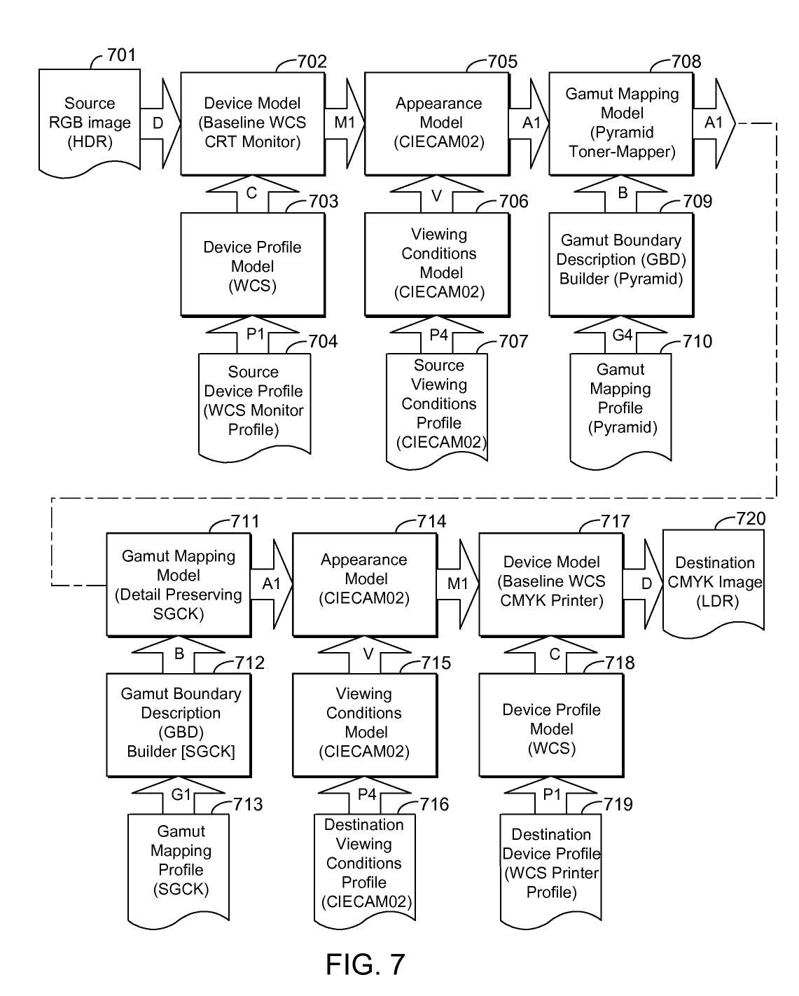

As one example of a script specifying at least a sequence of function modules and sources of parameters, the following example relating to a pyramid tone-mapper spatial color management workflow is provided, as shown in FIG. 7. A detailed description of a pyramid tone-mapper spatial color transformation is provided in U.S. Pat. No. 7,433,514. In this example, the following function modules are used:
Device Model 702 (Forward WCS Baseline CRT Monitor)
Device Model 717 (Inverse ICC Baseline CMYK Printer)
Appearance Model 705 (Forward CIECAM02)
Appearance Model 714 (Inverse CIECAM02)
Gamut Mapping Model 708(Pyramid Tone-Mapper)
Gamut Mapping Model 711 (Detail Preserving SGCK)
Device Profile Model 703 (WCS)
Device Profile Model 718 (WCS)
Viewing Conditions Model 706 (CIECAM02)
Viewing Conditions Model 715 (CIECAM02)
Gamut Boundary Description (GBD) Builder 709 (Pyramid)
Gamut Boundary Description (GBD) Builder 712 (SGCK)

In addition, the following interface definitions are used:
D Device Color Data (N-Channel)
M1 Measurement Color Data (CIEXYZ Tristimulus)
A1 Appearance Color Data (CIECAM02)
C Device Characterization Data
Viewing Conditions Data
B Gamut Boundary Description Data
P1 Device Profile Data (WCS)
P4 Viewing Conditions Profile Data (CIECAM02)
G1 Gamut Mapping Profile Data (SGCK)
G4 Gamut Mapping Profile Data (Pyramid)

The script specifies a sequence of above-listed function modules and sources of parameters in the manner shown in FIG. 7, such that a pyramid tone-mapper spatial color management workflow is constructed.

In more detail, the source image 701 (i.e. the input image) is represented by RGB values, and these values are transformed into XYZ values by the Device Model 702 for the source device (i.e. the CRT Monitor). The Device Profile Model 703 interprets a WCS Monitor Source Profile 704 and supplies the information to the Device Model 702.

The XYZ values of the source image are converted to Appearance Space (for example, Jab or JCh) by the Appearance Model 705, which uses CIECAM02 in this embodiment. The Viewing Conditions Model 706 interprets the CIECAM02 Source Viewing Conditions Profile 707 and supplies the information to the Appearance Model 705.

The Pyramid Spatial Tone-Mapping Module 708 performs tone-mapping on the Appearance Space-values of the source image 701. The Pyramid Spatial Tone-Mapping Module 708 generates spatial and image-specific information for use during the tone-mapping operations, using gamut boundaries supplied by the GBD Builder 709 which interprets Gamut Mapping Profile 710.

After tone-mapping, the GBD Builder 712 constructs device gamut boundaries by interpreting Gamut Mapping Profile 713, and the gamut boundaries are provided to the Gamut Mapping Model 711 to perform gamut mapping using a Detail Preserving SGCK Algorithm. The GBD Builder 712 gathers device gamut data from the Device Models and converts the gamut data into Appearance Space, when necessary, using the Appearance Model 714.

The Appearance Model 714 performs an inverse CIECAM02 transform which converts the Appearance Space values to XYZ tristimulus values. The Viewing Conditions Model 715 interprets the CIECAM02 Destination Viewing Conditions Profile 716 and supplies the information to the Appearance Model 714.

The Device Model 717 for the destination device (i.e. the CMYK Printer) transforms the XYZ values of the image into values represented in the destination device color space, which in this example is the CMYK color space of the printer. The Device Profile Model 718 interprets the WCS Monitor Destination Profile 719 and supplies the device information to the Device Model 717 in order to generate the destination image 720.

In this way, function modules which implement color processing functionalities can be flexibly organized and reordered to build a color transformation workflow, where the workflow is customized according to a script such that new color management techniques are accommodated. By way of contrast, existing color management systems such as, for example, WCS, typically process images through a fixed workflow, despite providing interchangeable components within the fixed color transformation workflow.

The example described above is merely one example of a script specifying at least a sequence of function modules and sources of parameters. Many other types of color management workflows can be built based on a variety of different scripts.

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A color management module which builds a color transformation workflow for transforming source-side color image data into corresponding destination-side color image data, the color management module comprising:
a module library which includes plural module entries each corresponding to a respective function module which implements color processing functionality, wherein each module entry comprises at least a module locator specifying a location for the function module, an input interface definition which specifies an interface for input to the function module, and output interface definition which specifies an interface for output from the function module;
a profile library which includes plural profile entries each corresponding to a respective source of parameters that characterize a function module, wherein each profile entry comprises at least a profile locator specifying a location for the source of parameters, and a profile interface definition which specifies an interface for supply of the parameters to the function module characterized thereby;
wherein for at least some of the module entries of the module library, the module entry further comprises a profile interface definition which specifies an interface for supply of parameters which characterize the function module;
a script-driven configurator which interprets a script specifying at least a sequence of function modules and sources of parameters, wherein the configurator (1) accesses the module library to confirm that the input interface definition for one function module is compatible with the output interface definition for an immediately preceding function module, (2) accesses the profile library to confirm that the profile interface definition for each specified source of parameters is compatible with the profile interface definition of the function module characterized thereby, and (3) builds the color transformation workflow from the sequence of function modules and sources of parameters specified by the script, responsive to confirmation of compatibility of the interface definitions.

2. A color management module according to claim 1, wherein the configurator is constructed to resolve inconsistencies between an input interface definition for a first function module and an output interface definition for a second function module which immediately precedes the first function module.

3. A color management module according to claim 2, wherein the configurator resolves inconsistencies by searching through the module library to identify at least one intermediate function module which provides a consistent pathway of interface definitions, and by inserting the at least one intermediate function module between the first function module and the second function module,
wherein the at least one intermediate function module has an input interface definition consistent with the output interface definition for the first function module and an output interface definition consistent with the input interface definition for the second function module.

4. A color management module according to claim 3, wherein if by searching through the module library a plurality of candidates are identified, each of which resolves the inconsistencies, one of the plurality of candidates is selected to resolve the inconsistencies in accordance with a user input.

5. A color management module according to claim 3, wherein if by searching through the module library a plurality of candidates are identified, each of which resolves the inconsistencies, one of the plurality of candidates is automatically selected to resolve the inconsistencies based on an intent of the color transformation workflow.

6. A color management module according to claim 3, wherein if by searching through the module library a plurality of candidates are identified, each of which resolves the inconsistencies, one of the plurality of candidates is automatically selected to resolve the inconsistencies based on metadata of an image.

7. A color management module according to claim 3, wherein if by searching through the module library a plurality of candidates are identified, each of which resolves the inconsistencies, one of the plurality of candidates is automatically selected to resolve the inconsistencies based on color image data for an image.

8. A color management module according to claim 1, wherein the configurator comprises a script refinement module which refines the script based on a predetermined criteria.

9. A color management module according to claim 8, wherein the predetermined criteria is one, or any combination of, a user input, information included in the profile entry, and image attributes.

10. A color management module according to claim 1, wherein the configurator comprises a parser/interpreter which generates a raw module list based on the script.

11. A color management module according to claim 1, wherein the configurator comprises a module interface connection checker which determines whether the input interface definition for one function module is compatible with the output interface definition for an immediately preceding function module.

12. A color management module according to claim 11, wherein the module interface connection checker resolves inconsistencies between an input interface definition for a first function module and an output interface definition for a second function module which immediately precedes the first function module.

13. A color management module according to claim 1, wherein the configurator comprises a transformation workflow generator which builds the color transformation workflow.

14. A color management module according to claim 1, the color management module further comprising an initializer which generates a module interface table based on the module library.

15. A color management module according to claim 1, wherein for at least some of the module entries of the module library, the module entry comprises plural input interface definitions including two or more of at least a device-dependent input interface definition, an XYZ input interface definition, an L*a*b* input interface definition, a Jab input interface definition, a profile connection space (PCS) input interface definition, and a spectral input interface definition.

16. A color management module according to claim 1, wherein for at least some of the module entries of the module library, the module entry comprises plural output interface definitions including two or more of at least a device-dependent output interface definition, an XYZ output interface definition, an L*a*b* output interface definition, a Jab output interface definition, a profile connection space (PCS) output interface definition, and a spectral output interface definition.

17. A color management module according to claim 1, wherein for at least some of the profile entries of the profile library, the profile entry includes plural profile interface definitions.

18. A color management module according to claim 1, wherein for at least some of the profile entries of the profile library, the source of parameters at the location specified by the profile locator generates the parameters from internal information.

19. A color management module according to claim 1, wherein for at least some of the profile entries of the profile library, the source of parameters at the location specified by the profile locator generates the parameters from internal information pertaining to ICC PCS viewing conditions.

20. A color management module according to claim 1, wherein for at least some of the profile entries of the profile library, the source of parameters at the location specified by the profile locator generates the parameters by using access to a file system to acquire information from which the parameters are generated.

21. A color management module according to claim 1, wherein the module library further includes supplemental function modules,
wherein each supplemental function module executes functionality to supply supplemental information to a function module which implements color processing functionality,
wherein the functionality is at least one of interpreting a device profile and generating a gamut boundary description,
wherein each supplemental function module supplies supplemental information to the function module via a supplemental interface, and
wherein the supplemental information includes at least one of device characterization data, viewing conditions, and gamut boundary descriptions.

22. A color management method for building a color transformation workflow for transforming source-side color image data into corresponding destination-side color image data;
wherein the color management method is executable by a computer which has access to a module library and to a profile library,
wherein the module library includes plural module entries each corresponding to a respective function module which implements color processing functionality, wherein each module entry comprises at least a module locator specifying a location for the function module, an input interface definition which specifies an interface for input to the function module, and an output interface definition which specifies an interface for output from the function module, wherein for at least some of the module entries of the module library, the module entry further comprises a profile interface definition which specifies an interface for supply of parameters which characterize the function module,
wherein the profile library includes plural profile entries each corresponding to a respective source of parameters that characterize a function module, wherein each profile entry comprises at least a profile locator specifying a location for the source of parameters, and the profile interface definition which specifies an interface for supply of the parameters to the function module characterized thereby, and
wherein the color management method comprises:
receiving and interpreting a script specifying at least a sequence of function modules and sources of parameters;
accessing the module library to confirm that the input interface definition for one function module specified in the script is compatible with the output interface definition for an immediately preceding function module specified in the script;
accessing the profile library to confirm that the profile interface definition for each specified source of parameters is compatible with the profile interface definition of the function module characterized thereby; and
building the color transformation workflow from the sequence of function modules and sources of parameters specified by the script, responsive to confirmation of compatibility of the interface definitions.

23. A color management method according to claim 22, wherein inconsistencies between an input interface definition for a first function module and an output interface definition for a second function module which immediately precedes the first function module are resolved.

24. A color management method according to claim 23, wherein the inconsistencies are resolved by searching through the module library to identify at least one intermediate function module which provides a consistent pathway of interface definitions, and by inserting the at least one intermediate function module between the first function module and the second function module,
wherein the at least one intermediate function module has an input interface definition consistent with the output interface definition for the first function module and an output interface definition consistent with the input interface definition for the second function module.

25. A color management method according to claim 24, wherein if by searching through the module library a plurality of candidates are identified, each of which resolves the inconsistencies, one of the plurality of candidates is selected to resolve the inconsistencies in accordance with a user input.

26. A color management method according to claim 24, wherein if by searching through the module library a plurality of candidates are identified, each of which resolves the inconsistencies, one of the plurality of candidates is automatically selected to resolve the inconsistencies based on an intent of the color transformation workflow.

27. A color management method according to claim 24, wherein if by searching through the module library a plurality of candidates are identified, each of which resolves the inconsistencies, one of the plurality of candidates is automatically selected to resolve the inconsistencies based on metadata of an image.

28. A color management method according to claim 24, wherein if by searching through the module library a plurality of candidates are identified, each of which resolves the inconsistencies, one of the plurality of candidates is automatically selected to resolve the inconsistencies based on color image data for an image.

29. A color management method according to claim 22, wherein the method further comprises refining the script based on a predetermined criteria.

30. A color management method according to claim 29, wherein the predetermined criteria is one, or any combination of, a user input, information included in the profile entry, and image attributes.

31. A color management method according to claim 22, wherein the method further comprises generating a raw module list based on the script.

32. A color management method according to claim 22, wherein the method further comprises generating a module interface table based on the module library.

33. A color management method according to claim 22, wherein for at least some of the module entries of the module library, the module entry comprises plural input interface definitions including two or more of at least a device-dependent input interface definition, an XYZ input interface definition, an L*a*b* input interface definition, a Jab input interface definition, a profile connection space (PCS) input interface definition, and a spectral input interface definition.

34. A color management method according to claim 22, wherein for at least some of the module entries of the module library, the module entry comprises plural output interface definitions including two or more of at least a device-dependent output interface definition, an XYZ output interface definition, an L*a*b* output interface definition, a Jab output interface definition, a profile connection space (PCS) output interface definition, and a spectral output interface definition.

35. A color management method according to claim 22, wherein for at least some of the profile entries of the profile library, the profile entry includes plural profile interface definitions.

36. A color management method according to claim 22, wherein for at least some of the profile entries of the profile library, the source of parameters at the location specified by the profile locator generates the parameters from internal information.

37. A color management method according to claim 22, wherein for at least some of the profile entries of the profile library, the source of parameters at the location specified by the profile locator generates the parameters from internal information pertaining to ICC PCS viewing conditions.

38. A color management method according to claim 22, wherein for at least some of the profile entries of the profile library, the source of parameters at the location specified by the profile locator generates the parameters by using access to a file system to acquire information from which the parameters are generated.

39. A color management method according to claim 22, wherein the module library further includes supplemental function modules,
wherein each supplemental function module executes functionality to supply supplemental information to a function module which implements color processing functionality,
wherein the functionality is at least one of interpreting a device profile and generating a gamut boundary description,
wherein each supplemental function module supplies supplemental information to the function module via a supplemental interface, and
wherein the supplemental information includes at least one of device characterization data, viewing conditions, and gamut boundary descriptions.

40. A color management apparatus for building a color transformation workflow for transforming source-side color image data into corresponding destination-side color image data, the color management apparatus comprising:
a computer-readable memory which stores computer-executable process steps, a module library and a profile library; and
a processor constructed to execute the computer-executable process steps stored in the memory;
wherein the module library includes plural module entries each corresponding to a respective function module which implements color processing functionality, wherein each module entry comprises at least a module locator specifying a location for the function module, an input interface definition which specifies an interface for input to the function module, and an output interface definition which specifies an interface for output from the function module, wherein for at least some of the module entries of the module library, the module entry further comprises a profile interface definition which specifies an interface for supply of parameters which characterize the function module,
wherein the profile library includes plural profile entries each corresponding to a respective source of parameters that characterize a function module, wherein each profile entry comprises at least a profile locator specifying a location for the source of parameters, and the profile interface definition which specifies an interface for supply of the parameters to the function module characterized thereby, and
wherein the process steps stored in the memory cause the processor to convert source-side color image data into corresponding destination-side color image data, and include computer-executable process steps to:
receive and interpret a script specifying at least a sequence of function modules and sources of parameters;
access the module library to confirm that the input interface definition for one function module specified in the script is compatible with the output interface definition for an immediately preceding function module specified in the script;
access the profile library to confirm that the profile interface definition for each specified source of parameters is compatible with the profile interface definition of the function module characterized thereby; and
build the color transformation workflow from the sequence of function modules and sources of parameters specified by the script, responsive to confirmation of compatibility of the interface definitions.

41. A color management apparatus according to claim 40, wherein inconsistencies between an input interface definition for a first function module and an output interface definition for a second function module which immediately precedes the first function module are resolved.

42. A color management apparatus according to claim 41, wherein the inconsistencies are resolved by searching through the module library to identify at least one intermediate function module which provides a consistent pathway of interface definitions, and by inserting the at least one intermediate function module between the first function module and the second function module,
wherein the at least one intermediate function module has an input interface definition consistent with the output interface definition for the first function module and an output interface definition consistent with the input interface definition for the second function module.

43. A color management apparatus according to claim 42, wherein if by searching through the module library a plurality of candidates are identified, each of which resolves the inconsistencies, one of the plurality of candidates is selected to resolve the inconsistencies in accordance with a user input.

44. A color management apparatus according to claim 42, wherein if by searching through the module library a plurality of candidates are identified, each of which resolves the inconsistencies, one of the plurality of candidates is automatically selected to resolve the inconsistencies based on an intent of the color transformation workflow.

45. A color management apparatus according to claim 42, wherein if by searching through the module library a plurality of candidates are identified, each of which resolves the inconsistencies, one of the plurality of candidates is automatically selected to resolve the inconsistencies based on metadata of an image.

46. A color management apparatus according to claim 42, wherein if by searching through the module library a plurality of candidates are identified, each of which resolves the inconsistencies, one of the plurality of candidates is automatically selected to resolve the inconsistencies based on color image data for an image.

47. A color management apparatus according to claim 40, wherein the process steps stored in the memory further include computer-executable process steps to refine the script based on a predetermined criteria.

48. A color management apparatus according to claim 47, wherein the predetermined criteria is one, or any combination of, a user input, information included in the profile entry, and image attributes.

48. A color management apparatus according to claim 40, wherein the process steps stored in the memory further include computer-executable process steps to generate a raw module list based on the script.

50. A color management apparatus according to claim 40, wherein the process steps stored in the memory further include computer-executable process steps to generate a module interface table based on the module library.

51. A color management apparatus according to claim 40, wherein for at least some of the module entries of the module library, the module entry comprises plural input interface definitions including two or more of at least a device-dependent input interface definition, an XYZ input interface definition, an L*a*b* input interface definition, a Jab input interface definition, a profile connection space (PCS) input interface definition, and a spectral input interface definition.

52. A color management apparatus according to claim 40, wherein for at least some of the module entries of the module library, the module entry comprises plural output interface definitions including two or more of at least a device-dependent output interface definition, an XYZ output interface definition, an L*a*b* output interface definition, a Jab output interface definition, a profile connection space (PCS) output interface definition, and a spectral output interface definition.

53. A color management apparatus according to claim 40, wherein for at least some of the profile entries of the profile library, the profile entry includes plural profile interface definitions.

54. A color management apparatus according to claim 40, wherein for at least some of the profile entries of the profile library, the source of parameters at the location specified by the profile locator generates the parameters from internal information.

55. A color management apparatus according to claim 40, wherein for at least some of the profile entries of the profile library, the source of parameters at the location specified by the profile locator generates the parameters from internal information pertaining to ICC PCS viewing conditions.

56. A color management apparatus according to claim 40, wherein for at least some of the profile entries of the profile library, the source of parameters at the location specified by the profile locator generates the parameters by using access to a file system to acquire information from which the parameters are generated.

57. A color management apparatus according to claim 40, wherein the module library further includes supplemental function modules,
wherein each supplemental function module executes functionality to supply supplemental information to a function module which implements color processing functionality,
wherein the functionality is at least one of interpreting a device profile and generating a gamut boundary description,
wherein each supplemental function module supplies supplemental information to the function module via a supplemental interface, and
wherein the supplemental information includes at least one of device characterization data, viewing conditions, and gamut boundary descriptions.

58. A computer-readable memory medium on which is stored computer-executable process steps for causing a computer to build a color transformation workflow for transforming source-side color image data into corresponding destination-side color image data;
the computer-readable memory medium further storing a module library and a profile library,
wherein the module library includes plural module entries each corresponding to a respective function module which implements color processing functionality, wherein each module entry comprises at least a module locator specifying a location for the function module, an input interface definition which specifies an interface for input to the function module, and an output interface definition which specifies an interface for output from the function module, wherein for at least some of the module entries of the module library, the module entry further comprises a profile interface definition which specifies an interface for supply of parameters which characterize the function module,
wherein the profile library includes plural profile entries each corresponding to a respective source of parameters that characterize a function module, wherein each profile entry comprises at least a profile locator specifying a location for the source of parameters, and the profile interface definition which specifies an interface for supply of the parameters to the function module characterized thereby, and
wherein the process steps comprise:
receiving and interpreting a script specifying at least a sequence of function modules and sources of parameters;
accessing the module library to confirm that the input interface definition for one function module specified in the script is compatible with the output interface definition for an immediately preceding function module specified in the script;
accessing the profile library to confirm that the profile interface definition for each specified source of parameters is compatible with the profile interface definition of the function module characterized thereby; and
building the color transformation workflow from the sequence of function modules and sources of parameters specified by the script, responsive to confirmation of compatibility of the interface definitions.

59. A computer-readable memory medium according to claim 58, wherein inconsistencies between an input interface definition for a first function module and an output interface definition for a second function module which immediately precedes the first function module are resolved.

60. A computer-readable memory medium according to claim 59, wherein the inconsistencies are resolved by searching through the module library to identify at least one intermediate function module which provides a consistent pathway of interface definitions, and by inserting the at least one intermediate function module between the first function module and the second function module,
wherein the at least one intermediate function module has an input interface definition consistent with the output interface definition for the first function module and an output interface definition consistent with the input interface definition for the second function module.

61. A computer-readable memory medium according to claim 60, wherein if by searching through the module library a plurality of candidates are identified, each of which resolves the inconsistencies, one of the plurality of candidates is selected to resolve the inconsistencies in accordance with a user input.

62. A computer-readable memory medium according to claim 60, wherein if by searching through the module library a plurality of candidates are identified, each of which resolves the inconsistencies, one of the plurality of candidates is automatically selected to resolve the inconsistencies based on an intent of the color transformation workflow.

63. A computer-readable memory medium according to claim 60, wherein if by searching through the module library a plurality of candidates are identified, each of which resolves the inconsistencies, one of the plurality of candidates is automatically selected to resolve the inconsistencies based on metadata of an image.

64. A computer-readable memory medium according to claim 60, wherein if by searching through the module library a plurality of candidates are identified, each of which resolves the inconsistencies, one of the plurality of candidates is automatically selected to resolve the inconsistencies based on color image data for an image.

65. A computer-readable memory medium according to claim 58, wherein the process steps further comprise refining the script based on a predetermined criteria.

66. A computer-readable memory medium according to claim 65, wherein the predetermined criteria is one, or any combination of, a user input, information included in the profile entry, and image attributes.

67. A computer-readable memory medium according to claim 58, wherein the process steps further comprise generating a raw module list based on the script.

68. A computer-readable memory medium according to claim 58, wherein the process steps further comprise generating a module interface table based on the module library.

69. A computer-readable memory medium according to claim 58, wherein for at least some of the module entries of the module library, the module entry comprises plural input interface definitions including two or more of at least a device-dependent input interface definition, an XYZ input interface definition, an L*a*b* input interface definition, a Jab input interface definition, a profile connection space (PCS) input interface definition, and a spectral input interface definition.

70. A computer-readable memory medium according to claim 58, wherein for at least some of the module entries of the module library, the module entry comprises plural output interface definitions including two or more of at least a device-dependent output interface definition, an XYZ output interface definition, an L*a*b* output interface definition, a Jab output interface definition, a profile connection space (PCS) output interface definition, and a spectral output interface definition.

71. A computer-readable memory medium according to claim 58, wherein for at least some of the profile entries of the profile library, the profile entry includes plural profile interface definitions.

72. A computer-readable memory medium according to claim 58, wherein for at least some of the profile entries of the profile library, the source of parameters at the location specified by the profile locator generates the parameters from internal information.

73. A computer-readable memory medium according to claim 58, wherein for at least some of the profile entries of the profile library, the source of parameters at the location specified by the profile locator generates the parameters from internal information pertaining to ICC PCS viewing conditions.

74. A computer-readable memory medium according to claim 58, wherein for at least some of the profile entries of the profile library, the source of parameters at the location specified by the profile locator generates the parameters by using access to a file system to acquire information from which the parameters are generated.

75. A computer-readable memory medium according to claim 58, wherein the module library further includes supplemental function modules,
wherein each supplemental function module executes functionality to supply supplemental information to a function module which implements color processing functionality,
wherein the functionality is at least one of interpreting a device profile and generating a gamut boundary description,
wherein each supplemental function module supplies supplemental information to the function module via a supplemental interface, and
wherein the supplemental information includes at least one of device characterization data, viewing conditions, and gamut boundary descriptions.
